(19) United States
(12) Patent Application Publication
(10) Pub. No.: US 2014/0033018 A1
(43) Pub. Date: Jan. 30, 2014

(54) METHOD AND SYSTEM FOR AUTOMATICALLY GENERATING SOCIAL NETWORK SITE PAGE BASED ON ELECTRONIC DOCUMENT CONTENT

(71) Applicants: Jeremy M. Pallai, Arlington, MA (US); Sean M. Connolly, Wakefield, MA (US); David Robert Chi-Wai Fung, Waltham, MA (US); Zain Zafar, Lahore (PK); Alfredo Ramos, Washington, DC (US)

(72) Inventors: Jeremy M. Pallai, Arlington, MA (US); Sean M. Connolly, Wakefield, MA (US); David Robert Chi-Wai Fung, Waltham, MA (US); Zain Zafar, Lahore (PK); Alfredo Ramos, Washington, DC (US)

(73) Assignee: Vistaprint Technologies Limited

(21) Appl. No.: 13/562,291

(22) Filed: Jul. 30, 2012

(51) Int. Cl. G06F 17/00

(52) U.S. Cl. 715/234

(57) ABSTRACT

Customized social media page generation methods and tools for automated generation and coordination of a social media page with existing user customized products.

### BACKGROUND OF THE INVENTION

The present invention relates generally to creating products to have a coordinated look and feel, and more particularly to tools and methods for integrating digital content assets used in a user's electronic document into customized social media site content.

The Internet has for a couple of decades been used to relay information, advertise, and engage in e-commerce. More recently, businesses are increasingly turning to social media networks to publish messages, advertise, and attract and retain customers. With the increase in web site building and publication tools, many users who might not otherwise have the time or skill to create their own websites or the money to hire an outside consultant are now publishing to the World Wide Web to be accessible via the Internet. For example, such tools often provide web page templates that allow a user to enter personalized content and select web page layout, styles, fonts, colors, etc., and then immediately publish the completed pages to the Internet.

More recently, the addition of data connectivity capability to cellular phones, resulting in what is now commonly referred to as a “smartphone”, has transformed not only the phone industry but also the rate of communication between such users and their accompanying expectations of such devices. Smartphone users now connect directly to the Internet and demand the same capabilities they would have had were they browsing the Internet using a traditional computer.

Furthermore, with the rising popularity of social media networks and service providers such as Facebook, LinkedIn, and Twitter, the methods and channels for advertising and connecting to customers have become prolific.

At the present number of websites accessible over the Internet (current estimates as of early 2012 are in the hundreds of millions of websites), and as the number of web sites and web pages increases, the importance of having an Internet presence, including a website, a mobile-ready website, and pages or feeds on all the big social media networks, cannot be underestimated.

In order to assist a user to quickly establish an “online” presence, several websites offer website building tools, often in conjunction with a domain name registration service, that provide a user interface for guiding the user through a series of questions and tools to select and configure the layout, content, and order of web pages on the user's website. Such website building tools, for example as provided by Vistaprint.com and by Webs.com, provide a number of tools, accessible via an intuitive user interface, that allow a user to select a theme (e.g., coordinated graphics(s) and/or image(s) that appear as background to actual user-inserted content, along with associated font and color schemes), a layout, a page order, and user-inserted content such as text, images, video, sound, etc. Such tools may also include graphical widgets (or controls) that upon activation by the user, allow the user to add functionality to the web page. For example, widgets often include such functionality as adding a map to the web page, adding a form, etc.

Due to the increasing popularity of social media sites, website building tools now often include one or more widgets for connecting the website to one or more respective social media sites. For example, a company may develop a company website, and may also provide a control on the website allowing a visitor to the website to socially link to the company's social media service page or content feed where the company posts and/or feeds fresh (timely updated and often transient) information. For example, one social media service is the well-known social networking service Facebook. Subscribers or “Fans” of a company can “Like” the company to join the social network and to access a “Fan” page to receive special offers and view company information. When a company fan page is updated, “friends” may receive notification of the new page updates. Another well-known social media service is Twitter, which allows Internet users to “follow” a Twitter account holder. Twitter followers receive short text-based messages called “Tweets”, typically as a text message. Many other social media services exist, but each is oriented towards providing frequently changing and updated content and then notifying its interested social network of subscribers of the updates.

While website building tools often do allow a user to insert social media controls in a web page, the user must then use different tools specific to the social media sites to set up and add content to the respective social media sites on which they have a presence. The disconnect between the website building tool(s) and the social media sitebuilding tool(s) means that the user (or company) must manually determine what content should appear on each site (or page), and furthermore must ensure that the content and styling ports with the correct format and dimensions so that the content will be visually coordinated in terms of using the same fonts, color scheme, styles and themes when viewed in the different media sites and on different content viewing mediums.

Many small businesses and other individuals do not have the time, knowledge, money, and/or desire to port coordinated content across multiple types of electronic media sites and/or to ensure that identical or similar content styling such as themes, styling, font schemes, and color schemes, are used across different promotional products such as business cards, brochures, websites and social media pages. These customers need to be able to develop visually coordinated content for a single product (such as a business card, a website, etc.), and then to have the themes, styling, font schemes, and color schemes automatically ported and integrated to as many other types of products as possible, including social media service sites, in a short amount of time, in order to quickly present a visually coordinated line of promotional products and online presence.

### SUMMARY OF THE INVENTION

Embodiments of the invention include a system for building social media pages which includes a social media page building engine in first communication with a matching engine which identifies content assets associated with corresponding content assets in a customized electronic document representing a user's customized product, the social media page building engine receiving the identification of the identified content assets and building a social media page for a social media service, the social media page incorporating at least some of the identified content assets.

Embodiments of the invention further include a method for generating a social networking site page at a remote social networking site. The method includes steps of receiving content from an existing electronic document; automatically selecting, by one or more processors, at least some of the content from the existing electronic document; authenticating, by one or more processors, a user to the social networking site; automatically creating, by one or more processors, a page at the social networking site; and automatically, and without input from the user, provisioning the page with at least some of the selected content from the existing electronic document.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram of a networked environment;

FIG. 2 is a block diagram of an exemplary computing environment in which the invention may operate;

FIG. 3 is an example schematic diagram of an exemplary social media page;

FIG. 4 is a component schematic diagram of a system for building a customized social media page based on an existing user document;

FIG. 5 is a flowchart of an exemplary method for building a customized social media page based on an existing user document;

FIG. 6A is a schematic diagram of an exemplary web page;

FIG. 6B is a component diagram of the web page of FIG. 6A;

FIG. 7 is a structural diagram of a portion of a product assets database; and

FIGS. 8A-8V together illustrate an example screen flow for the user case of a user design of a business card product and the offering of a matching social media page at a retail promotional products website.

### DETAILED DESCRIPTION

Although the present invention is described below by way of various embodiments that include specific structures and methods, embodiments that include alternative structures and methods may be employed without departing from the principles of the invention described herein.

In general, embodiments described below feature systems and methods for automatically generating a customized social media page for a social media service based on styling and content assets from a user's existing product. A preferred embodiment of the present invention features automatically identifying styling and content assets of a user's previously created product, such as a user's website, an electronic representation of a user's printed promotional document such as a business card, a brochure, etc., and configuring corresponding assets of a social media page ready for publication to a social media service and which is customized specifically for the user.

In one embodiment, the present invention is implemented as a web-based service that may be accessed through the Internet, for example, using a Web browser. The service provides an interface that allows a user to view a customized social media page that was automatically created and customized by a server. The interface interacts with the user to obtain login information used to allow the server to authenticate the user to the social media service and to allow the customized social media page to be associated with the user's social media service account, and to allow the user to edit and publish the customized social media page.

An introduction to Internet-related technology is helpful in understanding the present invention. The Internet is a vast and expanding network of computers and other devices linked together by various telecommunications media, enabling the various components to exchange and share data. Web pages, websites (collections of related web pages organized under a particular domain), and social media pages, accessible through Internet, provide information about numerous businesses, products and services, as well as education, research, and entertainment.

A resource that is attached to the Internet is often referred to as a “host.” Examples of such resources include conventional computer systems that are made up of one or more processors, associated memory and other storage devices and peripherals, such as modems, networks interfaces and the like that allow for connection to the Internet or other networks. In most cases, the hosting resource may be embodied as hardware and/or software components of a server or other computer system that includes an interface module, which allows for some dialog with users and that may process information input by the user. Generally, such a server will be accessed through the Internet's graphical user interface, the World Wide Web, (e.g., via Web browsers) in the conventional fashion.

In order to facilitate communications between hosts, each host has a numerical Internet Protocol (IP) address. The IP address of a hypothetical host computer might be 69.17.223.11. Each host also has a unique “fully qualified domain name.” In the case of the hypothetical host 69.17.223.11, the “fully qualified domain name” might be “computer.domain.com”, the three elements of which are the hostname (“computer”), a domain name (“domain”) and a top-level domain (“com”). A given host looks up the IP address of other hosts on the Internet through a system known as domain name service.

A page of a website is addressable by way of a Uniform Resource Locator, or “URL”. A URL specifies three elements: (1) a transfer protocol; (2) a web server name or domain name; and (3) a path. The first element of the URL is a transfer protocol, most commonly “http” standing for hypertext transfer protocol, but others include “mailto” for electronic mail, “ftp” for file transfer protocol, and “nntp” for network news transfer protocol. The domain name indicates the name of the web server that stores the web page. The path indicates the location of web page on the named web server.

As previously indicated, in order to access the Internet most users rely on computer programs known as “Web browsers.” Commercially available Web browsers include such well-known programs as Microsoft Internet Explorer, Apple Safari, Google Chrome, and Mozilla Firefox, to name a few. If an Internet user desires to view a Web page hosted at www.domain.com, the Internet user might enter into a Web browser program the uniform resource locator (URL) “http://www.domain.com”.

Once a URL is entered into the browser, the request is routed to a Domain Name System (DNS) server capable of matching the domain name specified in the URL to a corresponding IP address of a web server hosting the requested web page. Thus, the DNS server ultimately matches an alphanumeric name such as www.domain.com with its numeric IP address 69.17.223.11.

When a host receives a request from the Internet, it returns the data in the file pointed to by the request to the client making the request. Such data may make up a Web page, which may include a text message, sound, image, video, or a combination of such elements. A user can move between Web pages through the use of hyperlinks, which are links to other pages or locations on pages on the Internet.

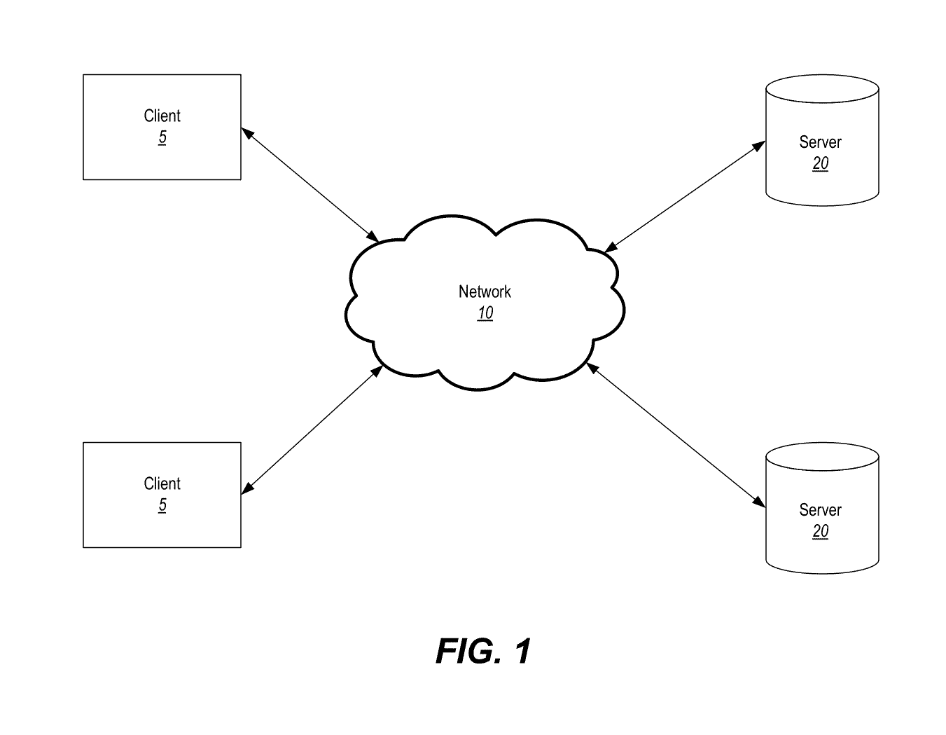

An integral component of the present invention is a computer server. Servers are computer programs that provide some service to other programs, called clients. A client 5 and server 20 of FIG. 1 communicate by means of message passing often over a network 10, and use some protocol, a set of formal rules describing how to transmit data, to encode the client's requests and/or responses and the server's responses and/or requests. The server may run continually waiting for client's requests and/or responses to arrive or it may be invoked by some higher-level continually running server that controls a number of specific servers.

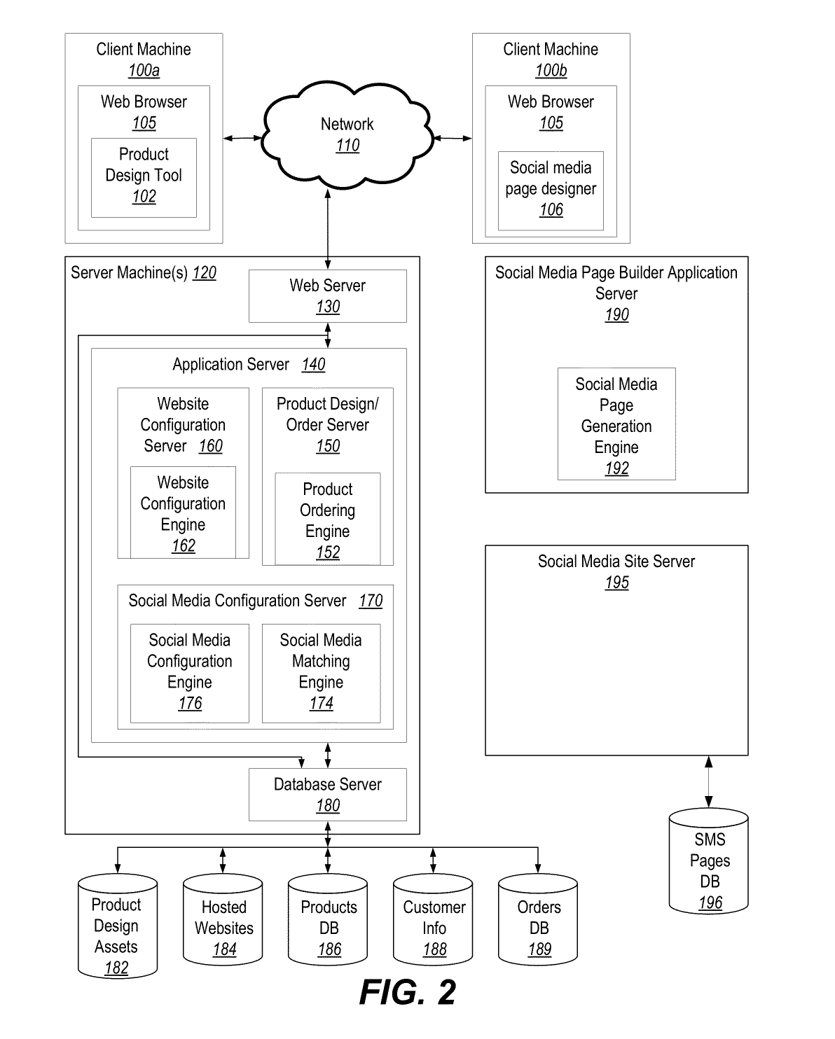

With these concepts in mind, an embodiment of a system architecture of the present invention is presented in FIG. 2. Services for automatically generating and configuring a page of a social media site (such as Facebook) may be accessed through client machines 100 that run browser applications 105 to provide graphical interfaces for a user to effectively use services for registering a site account and setting up, configuring, and publishing the site content. The client machines 100a, 100b communicate with a server machine 120 via a network 110, e.g. Internet. The server machine 120 includes such components of the present invention as a web server 130, an application server 140, a product design and ordering server 150, a website configuration server 160, a social media site configuration server 170, and a database server 180. While illustrated as executing on the server machine 120, it will be appreciated that these servers may run on other machines that are accessible by the server machine 120, and further that the server machine 120 may comprise one or more server machines working together to perform the functionality described herein. In an embodiment of the present invention, databases for storing customer information, website asset information, etc. are also stored at the server machine 120. However, it will be appreciated that databases may be stored at other machines and database data may be uploaded to the server machine 120 when necessary.

In an embodiment, the application server 140 comprises a product design and ordering server 150 that includes a product ordering engine 152 which downloads a product design tool 102 to the browser 105 of a client machine 100a to allow a user to select, design, and order a product such as business card, brochure, website, or other promotional product. The application server 150 also includes a website configuration server 160 which hosts a website configuration engine 162 through which customers can select a domain name and build a website for hosting by the web server 130.

The application server 140 may further include a social media service configuration server 170. The social media service configuration server 170 includes a social media page matching engine 174 and a social media page configuration engine 176. A 3^{rd} party social media page builder application server 190 hosts a social media page generate engine 192. The social media page generation engine 192 automatically generates and provisions a social media page for publication to a social media service server database 196 from which a social media service server 195 serves account holder social media pages. The social media page generation engine 192 provides a social media page designer 106 which allows user clients 100 to configure a social media page for publication to a 3^{rd} party social media service 195. Generally, the social media page builder application server 190 is operated by a 3^{rd} party provider different that the product retailer servers 120. However, in an alternative embodiment, the social media page builder application server may be owned and operated by the same party as the product retailer servers 120.

In accordance with embodiments of the invention, the social media page generation engine 172 utilizes the services of the matching engine 174 to identify one or more digital assets of an existing customer product such as a customer website or a previously ordered product such as a business card or brochure that will be identical to, or at least visually appear to coordinate with or match, at least some content and look and feel of the existing customer product. The social media page generation engine 192 at the social media page builder application server 190 interacts with the social media configuration server 170 to determine the identified digital assets, and generates a customized social media page which incorporates the identified digital assets such that the customized social media page is visually coordinated with the existing customer product. The social media page generation engine 192 configures and provisions a social media service account associated with the user at client 100b with the customized social media page.

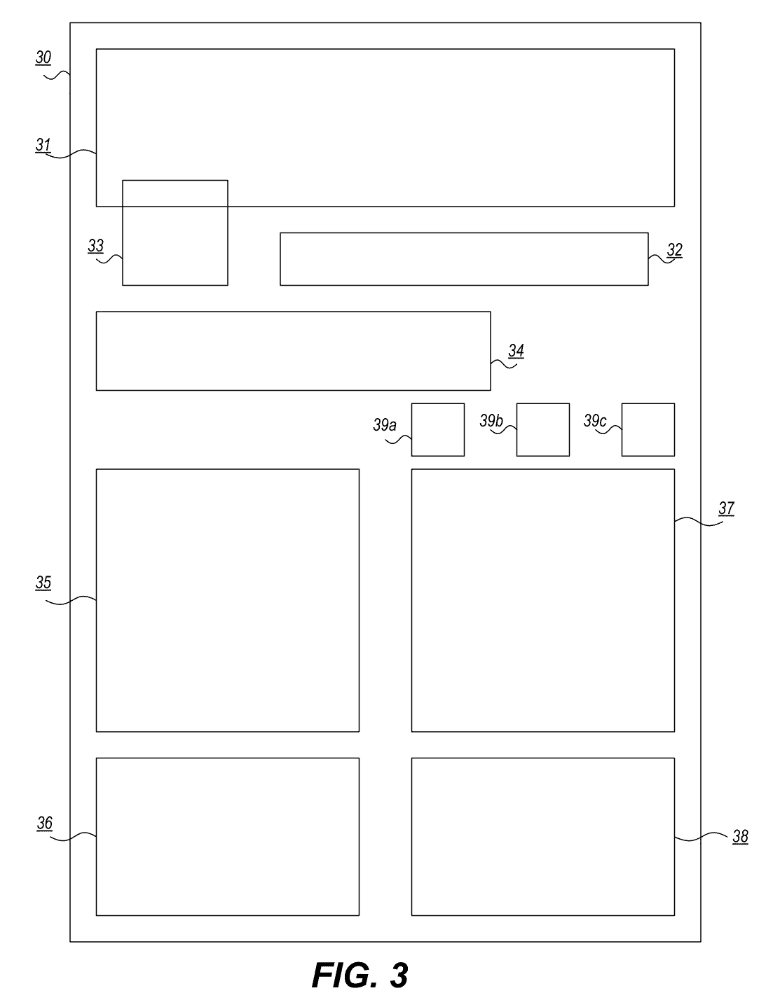

With reference now to FIG. 3, a social media site associated with a social media service account holder may consist of a home or “cover” page 30, an example of which is shown in FIG. 3. It will be appreciated that various different social media services may implement different formats of social media pages and that the page shown in FIG. 3 is by way of example only and not limitation. In general, a social media page 30 will include a layout with one or more areas 34-38 where the account holder can post content. The content is posted by the account holder via an administration page which provides various user-selectable controls which allow the user to add/edit/review/delete/publish content to one or more of their associated social media page(s). Viewers of an account holder's social media page in general see one or more images, text, video, audio. Some of the images, text, video, audio may be part of a non-changing theme of the page which remains the same and visible no matter what is posted on the page, while others of the images, text, video, audio may be part of the changing/updated content posted by the account holder. For example, the theme of the page may include a logo, company name, branding imagery, branding font styles and color schemes, and different labeled areas of the social media page where different types of content are posted. The posted content may change often, but the theme and layout of the page remains the same regardless of the posted content. With reference to FIG. 3, the example social media page 30 includes a cover image 31, the name of the business or page name 32, the logo of the business 33, different content areas 34, 35, 36, 37, 38, with different area content area labels. The example social media page also includes a font scheme which dictates what font to use to render various elements of the page, a color scheme which dictates what colors to use to render various elements of the page, and various styling components to use for different components (such as but not limited to line styles, shading, border styles, font and color styles, fill styles, etc.). A social media page may further include links 39a, 39b, 39c to one or more respective related social media pages, each comprising another social media page associated with the home or cover social media page.

For example, in one embodiment, the social media service is the social network service Facebook, owned and operated by Facebook, Inc. Facebook is a social networking tool that connects people with friends and businesses based on grouping characteristics such as family, friends, coworkers, interests, likes, and dislikes. A Facebook account allows an account holder to update subscribers (called “Fans” or “Friends”) of the account holder's site by posting messages, sharing news, thoughts, and status, and displaying photos, videos, etc. A business may use a Facebook page to interact with customers, provide information about the business, post offers, specials and advertisements, inform about upcoming events or other news, etc. A visitor to the page itself, or to a page containing a “Like” link to the company or personal Facebook page, can become a subscriber (a “Fan” or “Friend”) and will receive updates in a News Feed (e.g., RSS Feed) which pushes content to subscribers. Fans or Friends can also share the content with their linked Friends, who can then “Like” the content and share it with their Friends, and so on.

Unlike a traditional website, where content is typically published for more long-term information, social media sites are typically designed to post frequent changes and updates to reflect timely and more transient information. Thus, one may post often to a social media site (daily, multiple times per day, weekly, etc.), whereas the traditional website is designed for posting long-term information that tends not to change over time. Also unlike a traditional website, where anyone can create a web page using standard non-proprietary language, for example, using HTML, social media services are private 3^{rd} party services which often utilize proprietary languages and formats for publishing their social media pages. For example, the social media service Facebook will not receive a standard browser-renderable HTML document for publication as a Facebook page. Instead, Facebook provides an Application Programming Interface (API) which requires specific parameters and method calls to be made. The Facebook server(s) require user authentication to edit a user's Facebook page/profile, and further manage the generation of a browser-renderable page from the proprietary Facebook format(s).

Different social media services may provide corresponding Application Programming Interfaces (APIs) which expose methods and parameters to software application developers to allow 3^{rd}-party software providers to integrate with the particular social media service. Without providing the API, users would then be forced to utilize only the social media service itself to build pages and profiles served by the social media service. Thus, for example, 3^{rd}-party Facebook page builders have been developed to allow users to build Facebook pages and profiles, often offering intuitive user interfaces and widgets for quickly adding graphics, images, videos, and functionality to a page. These social media page builders interact with the user to obtain the desired look and feel of the page and to obtain user authentication information, and then interacts with the particular social media service (for example, Facebook) to authenticate the user and configure the user account with the user-customized social media page. For example, Pagemodo, owned by Webs.com, is a leading Facebook page creation tool. However, although such page creation tools exist, none provide any way to automatically create and coordinate Facebook page content to existing user products.

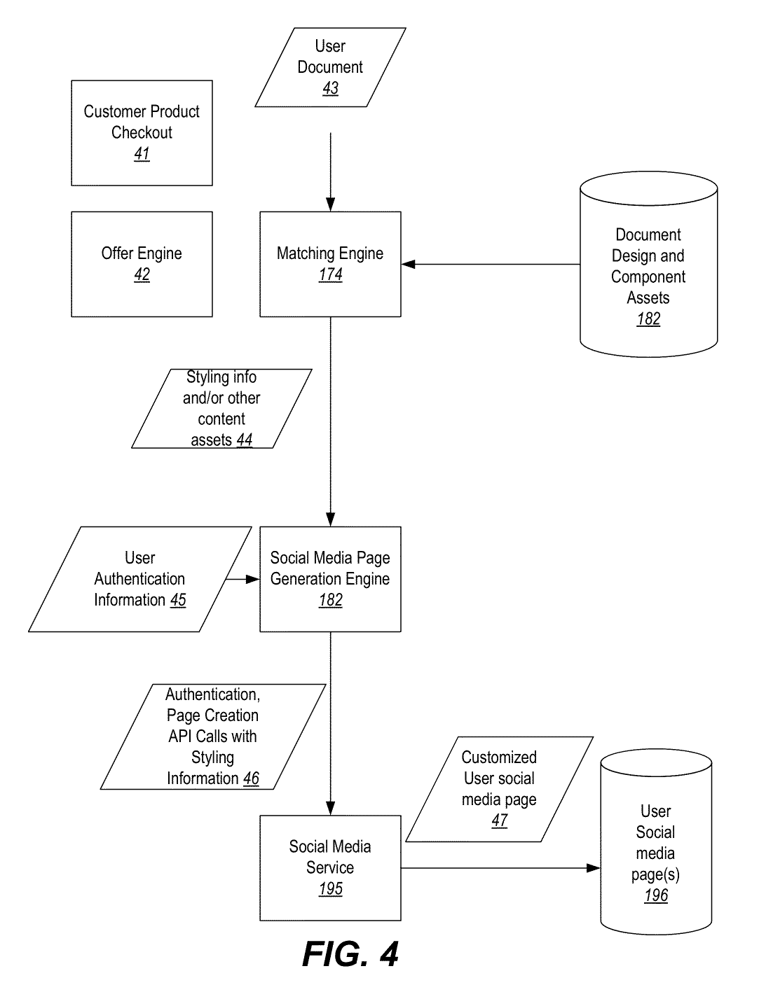

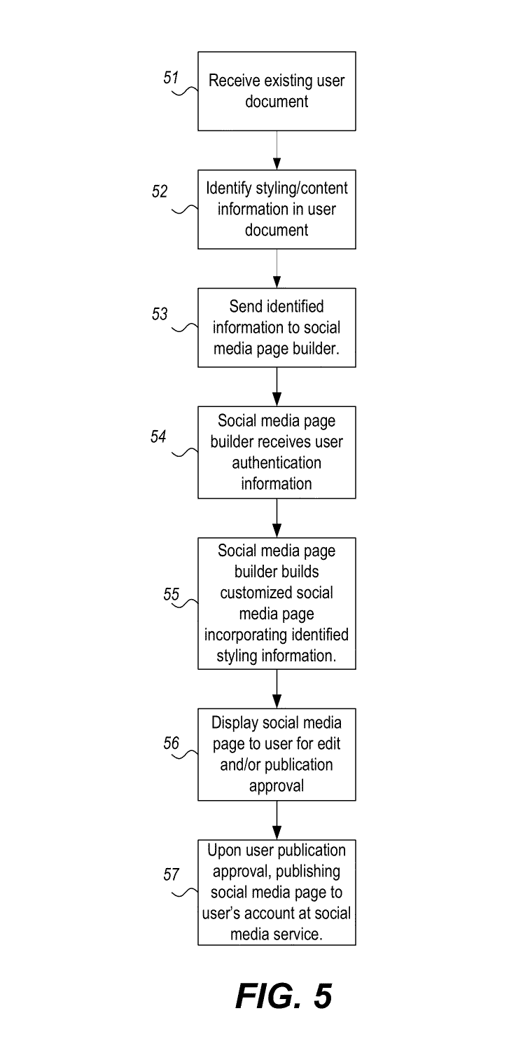

FIG. 4 is a component diagram, and FIG. 5 is a flowchart of an exemplary method, for building a customized social media page 47 based on an existing user document 43 which electronically represents a user's customized product (such as a web page, a business card, or some other promotional product). As illustrated, a matching engine 174 receives an existing user document 43 containing styling information associated with one or more elements of the existing user document (step 51). The matching engine 174 identifies content assets 182 associated with corresponding content assets in the user document (step 52) and sends it to a social media page builder application (step 53). A social media page building engine 182 receives the identification of the identified styling and/or content assets 44 (or alternatively the actual information or content assets themselves) and obtains user authentication information 45 for authentication a user to a particular social media service (step 54). The social media page building engine 182 builds a social media page 47 for publication to the particular social media service based on and incorporating at least some of the identified styling and/or content assets (step 55).

The social media page engine 182 may generate the customized social media page 47 which may be displayed on a display screen of a user's computing device (step 56). The generation of the customized social media page 47 may be initiated at the request of the user by clicking on a control or link on a web page or initiating a program application at the user's (client's) machine. Alternatively, the automated generation of the customized social media page may be performed automatically without the conscious request of the user. For example, the automated generation of the customized social media page may be triggered by the user completing a design for a different product and beginning a checkout process 41 at a retail product website. The automatic generation of the customized social media page may be generated as part of a cross-sell offer 42 for presentation to the user as an additional product that may interest the user, for example in building an online presence and business awareness. Upon presentation to the user, the user's approval may trigger an authentication process, whereby the user enters requested authentication information to be used by the server for authenticating the user to a user account at the social media service. Once authenticated, the user may be presented with additional editing options and a publication option which, when activated, publishes the customized social media page to the social media service and associates the page with the user's account (step 57).

To illustrate how at least one embodiment of the implementation of the operations of the matching engine, it is helpful to provide a description of how an existing user document such as a website is formatted. As know by those skilled in the art, a traditional website is a set of one or more web pages served by a web server at a particular domain name. A web page is typically a text document containing text and browser-interpretable instructions, such as the well-known Hypertext Markup Language (HTML or XHTML), Dynamic HTML (DHTML), Document Object Model (DOM), etc. With reference to FIG. 2, a browser 105 running on a client machine 100 requests a web page by specifying the Universal Resource Locator (URL) of the specific page, and upon receiving the requested page from the server 120, renders the page on the user's display screen by processing and executing the browser-interpretable instructions. Web pages may be linked to other web pages by way of hyperlinks placed within the page(s). Typically, a hyperlink specifies a URL of a web page, a position in the web page, or a resource accessible by the server serving the web page.

A typical website consists of a home page that is served when the URL specifies the domain name without specifying a particular path (e.g., www.mycompany.com). Additional pages belonging to a website may be specified by way of the path following the domain name in the URL. For example, a “Contact Us” web page for the www.mycompany.com website may be specified as “www.mycompany.com/ContactUs”, where the path “/ContactUs” in the URL indicates the location at the web server of the “Contact Us” web page.

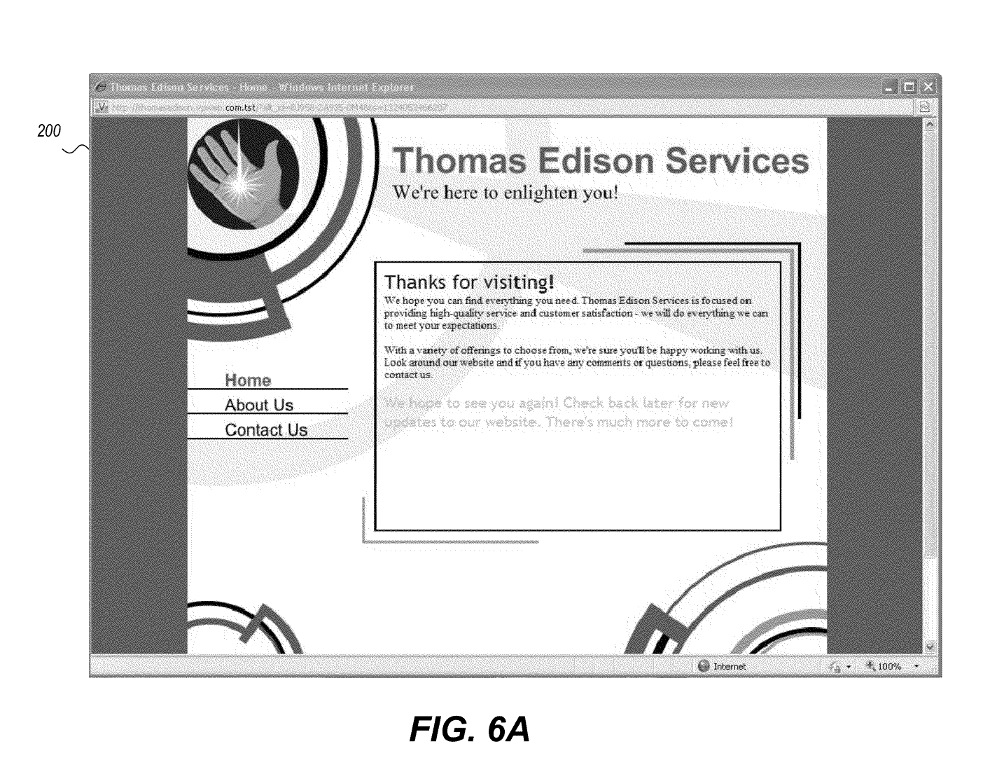

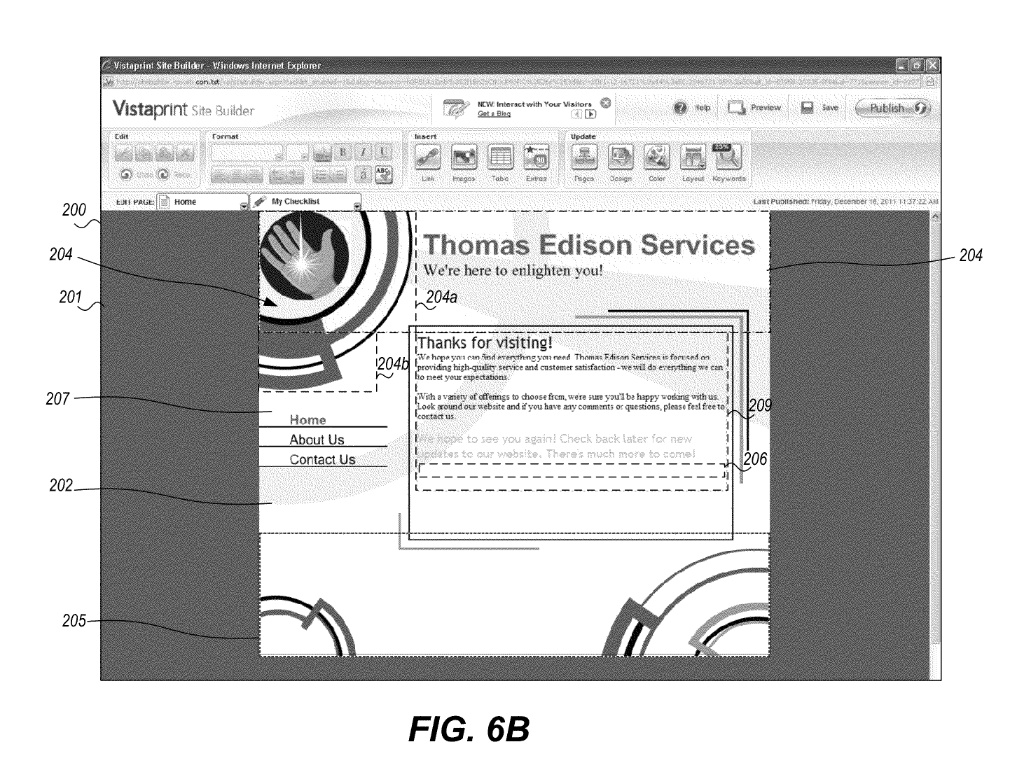

With reference now to FIG. 6A, a website may consist of a plurality of related web pages 200, each comprising a browser-renderable document (for example, an HTML document). In the example shown in FIG. 6A, a www. website includes a Home Page 200 (shown), a Contact page, an About Us page, a Products page, and one or more additional web pages. Returning to FIG. 2, in an embodiment, the web pages are typically created and updated using an interactive configuration and editing tool 102, hereinafter referred to as a “website building tool”. In one embodiment, the website building tool 102 is downloaded from the server 130 to the client machine 110 to run in the client browser 105. The website building tool 102 provides a graphical user interface that allows a creator or designer of a website to, among other actions, select page formats, add and modify content on the pages of the website, add or delete pages of the website, etc. Generally, the website building tool 102 receives user input for various formatting aspects, such as themes, layout, color and/or color scheme, text fonts, content (including text, images, videos, audio, and scripts). The user input typically is received via a graphical user interface (GUI) that presents various options and input areas and translates the selected options and user input into a browser-renderable language such as HTML.

In an embodiment, during editing of a web page of a website, the website building tool 102 modifies a copy of a selected corresponding current web page of the site. The modified copy of the edited web page is not visible to the public until it gets published to the hosted websites database 184. The website building tool 102 includes a publish control (such as a button), which allows the user of the website building tool 102 to publish the edited page once he or she is satisfied with any changes made to the page.

In an embodiment, the website building tool 102 includes a preview function which allows the website owner to preview the changes made to the page prior to publishing it. To preview the changes, a Preview button may, when clicked by the user using a mouse or other input device, trigger the loading and rendering of the edited page into a browser for display to the user. The Publish button triggers the writing of the HTML version of the edited page to the hosted web pages database, overwriting the corresponding existing page if one exists.

In a retail webhosting environment, a website building tool 102 may be offered to customers to assist them in designing and publishing their websites. When a customer of the retail webhosting site orders a website and uses the website building tool 102 to design the site, when the customer is satisfied with the design and requests publication of the site and to begin the checkout process, the webhosting retailer may wish to further assist the user in developing the customer's online presence by offering to assist the user in designing and publishing a coordinated (“matching”) social media page for publication by one or more social media services. In this type of environment, the server may include a social media configuration server 170 on which a social media matching engine 174 and social media configuration engine 176 are implemented.

In a retail promotional products environment, multiple promotional products such as business cards, brochures, pens, and other printed, embroidered, engraved or otherwise labeled promotional products, as well as digital products such as conventional and mobile websites and social media services, when a customer orders one type of promotional product, the retail promotional products server may automatically generate a customized social media page based on content and styling from the ordered product in order to present the customer with a visually coordinated social media page designed to assist the user in defining a coordinated look and feel across its promotional literature and products.

Using a user-designed customized website as an example of an existing user document, it is useful to first understand the various components of a conventional web page in order to understand how content and styling can be identified to develop a coordinated social media page customized for the user. FIG. 6A displays a Home page 200 of the example website. FIG. 6B illustrates an embodiment of various components that make up the anatomy of the Home page 200. As illustrated, the Home page 200 includes an outer background 201, an inner background 202, a header 203, a footer 205, a navigation panel 207, a repeatable middle portion 206, and a content area 209. In an embodiment, the user content area 209 may vertically expand and contract to fit the amount of content inserted in the user content area 209. As the user content 209 expands beyond the existing container size (in the vertical direction), one or more instances of the repeatable middle portion 206 are added to page so that the user content area does not expand into the footer 205. Conversely, when the user content 209 is edited to remove content such that the vertical space occupied by the user content allows one or more instances of the repeatable middle portion 206 to be removed from the page while still not resulting in the user content area overlapping the footer 205, then those one or more instances of the repeatable middle portion are removed automatically by the website building tool.

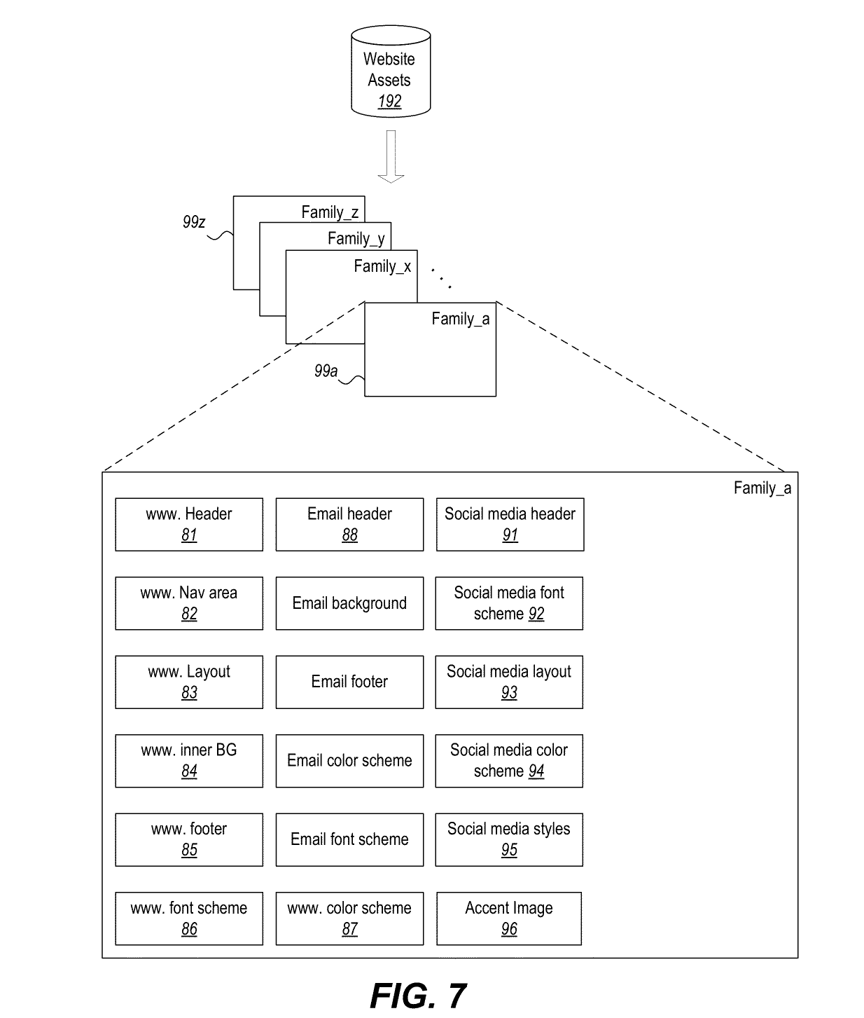

FIG. 7 depicts a structural diagram of a portion of a product assets database 192. The product assets database 192 contains components and descriptions such as website headers, navigational components, background images, inner background images, footers, layouts, color schemes, accent images, font schemes, template descriptions, and any type of component or scheme that may be used as a component in a web page. A web page may include a plurality of different components arranged (such as layouts, headers, footers, backgrounds, text components, and images) and/or applied (such as color schemes, font schemes, backgrounds, layouts, etc.) according to a page description (typically .html).

In order to allow for computer-automated product matching, such as websites, social media pages, email marketing campaigns, and printed products such as business cards, postcards, brochures, etc., the assets can be categorized into families of coordinated, or “matching”, assets. Matching assets are components that share a common image or look-and-feel such that when different matching assets are used across different type of products (such as websites, mobile websites, social media, email marketing and printed products), all of the different types of products appear to have a coordinate look—i.e., they appear to belong to the same set of coordinated products from the same business or user. This may be achieved by using one or more of the same image, color scheme, font scheme, etc., and/or by using multiple different images having a similar theme along with an identical color scheme, font scheme, or other component.

In an embodiment, components that are considered to “match” one another are considered to be in the same “family” of assets. Thus, a designer of a conventional www. website may have designed a www. header 81, www. navigation area 82, a layout 83, a www. inner background 84, a www. footer 85, a font scheme 86, and a color scheme 87. In order to generate matching email campaigns, the designer may also have created a matching Email header 88. In order to generate matching designs for business cards, postcards, and brochures, the designer may have generated corresponding matching printed product assets that are used by an automated design generation engine to create matching products.

In one embodiment, families of matching assets also preferably include matching social media assets. For example, when a designer generates website assets for a particular website design that can be automatically combined by a computer system to generate a web page, the designer may at that time also create a matching social media header 91 that is designed to fit in a header area of a social media page of a particular social media service, along with corresponding social media font scheme(s) 92, layout(s) 93, color scheme(s) 94, and other various styling information 95.

In some instances, the website designer may not have generated a social media header or other corresponding assets. In these instances, alternative techniques for generating social media styling components that coordinate with the website as closely as possible are necessitated. The particular path to follow depends in part on what assets are available from the family from which the website assets belong. For example, there may be a different asset in the same family that, although not designed specifically for a social media page, may be close enough in terms of size (i.e., data size) and dimensions. For example, often a header used in an email marketing message is narrower (such as 300 pixels wide) and is smaller in terms of data. Since the email marketing header 88 is close in width and is less data intensive, the email marketing header 88 could be used as the header in a mobile version of a website. In this case, if no social media page specific header asset existed in the family of assets, then the system could choose to use the email marketing header 88 as the header component for the social media page.

Alternatively, for any given family of assets, a representative accent image 96 could be associated with the family 99a. The accent image 96 could be an image that appears in some form or another on all products, both electronic (e.g., websites, email marketing, social media services) and printed (e.g., business cards, postcards, brochures, etc.). The accent image 96 could be incorporated by the social media page generation engine 172 into an image container in a generic social media page header.

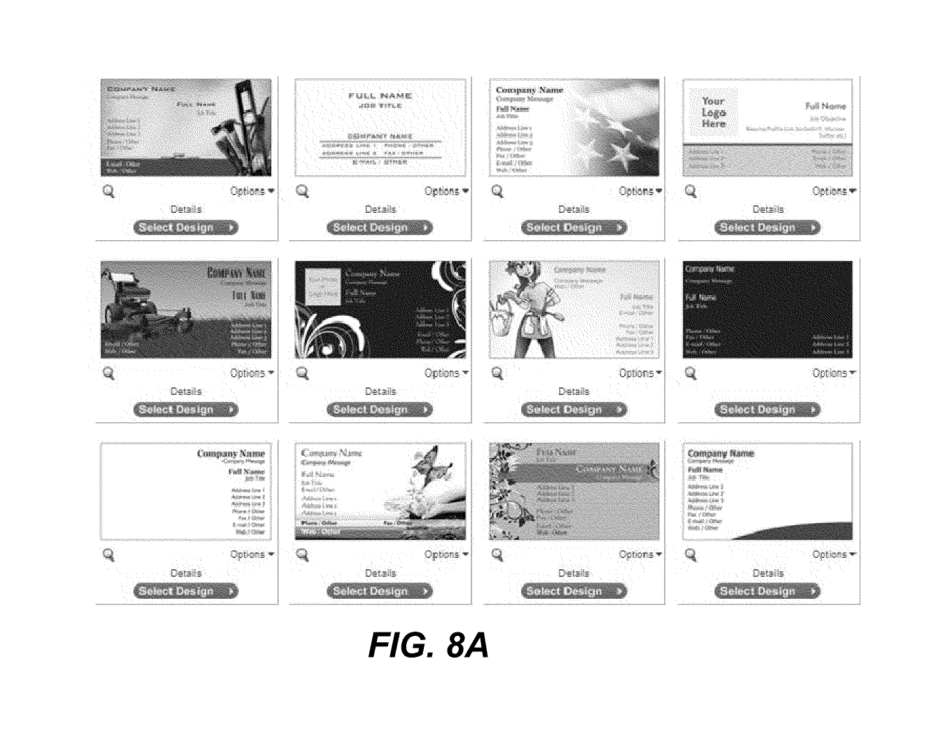

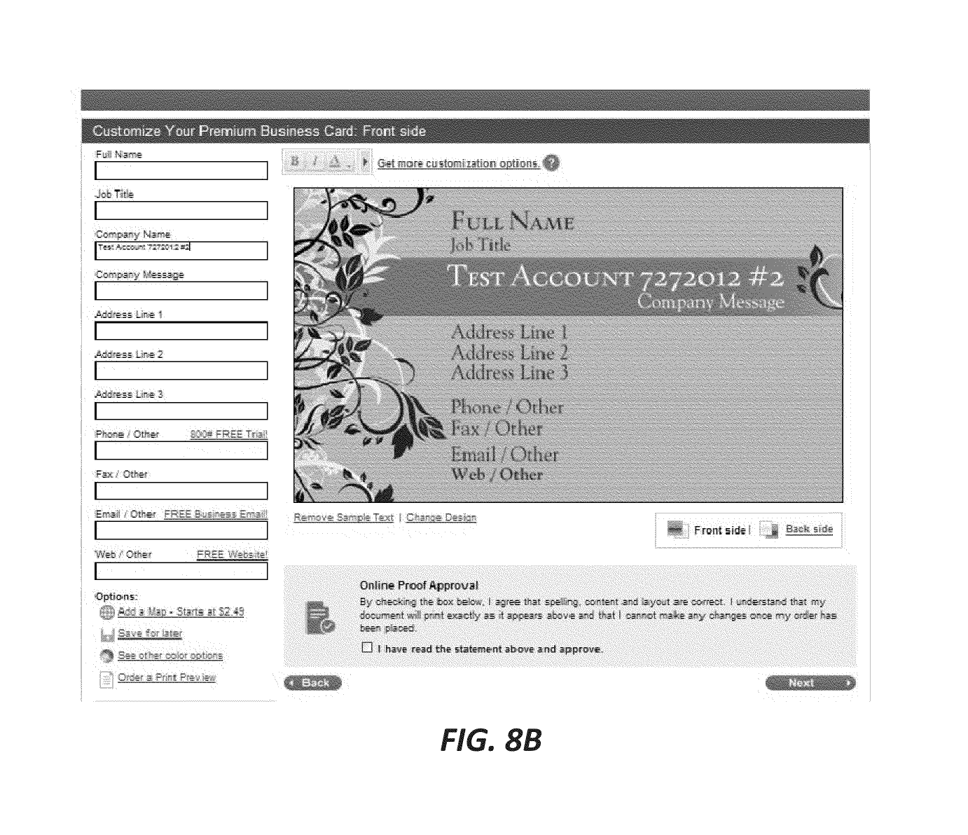

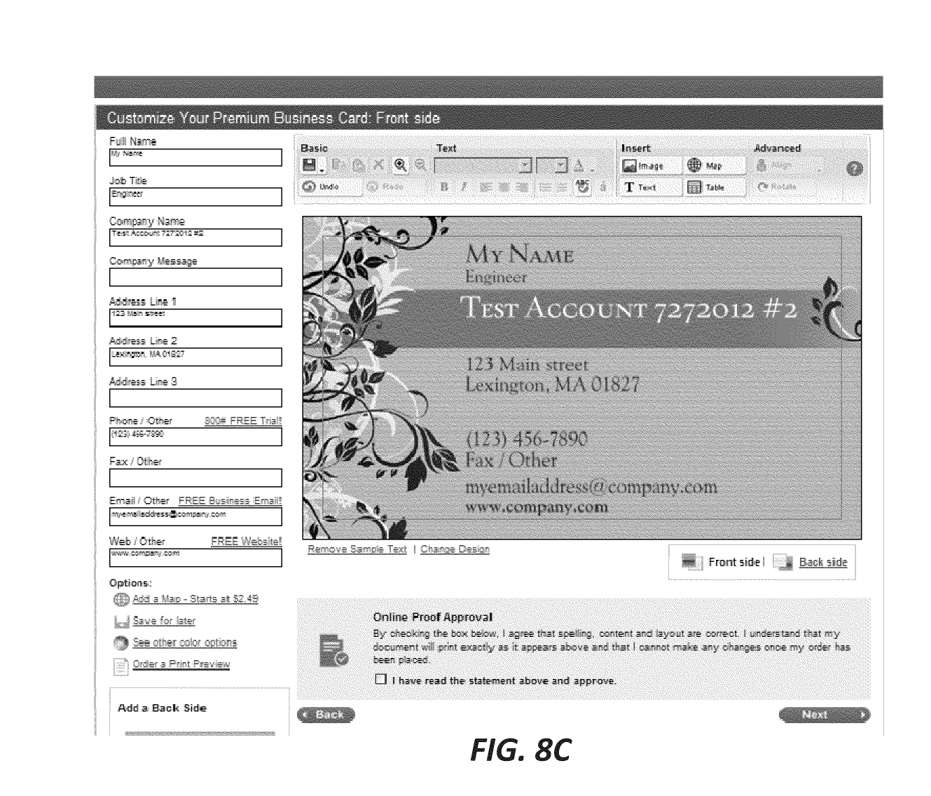

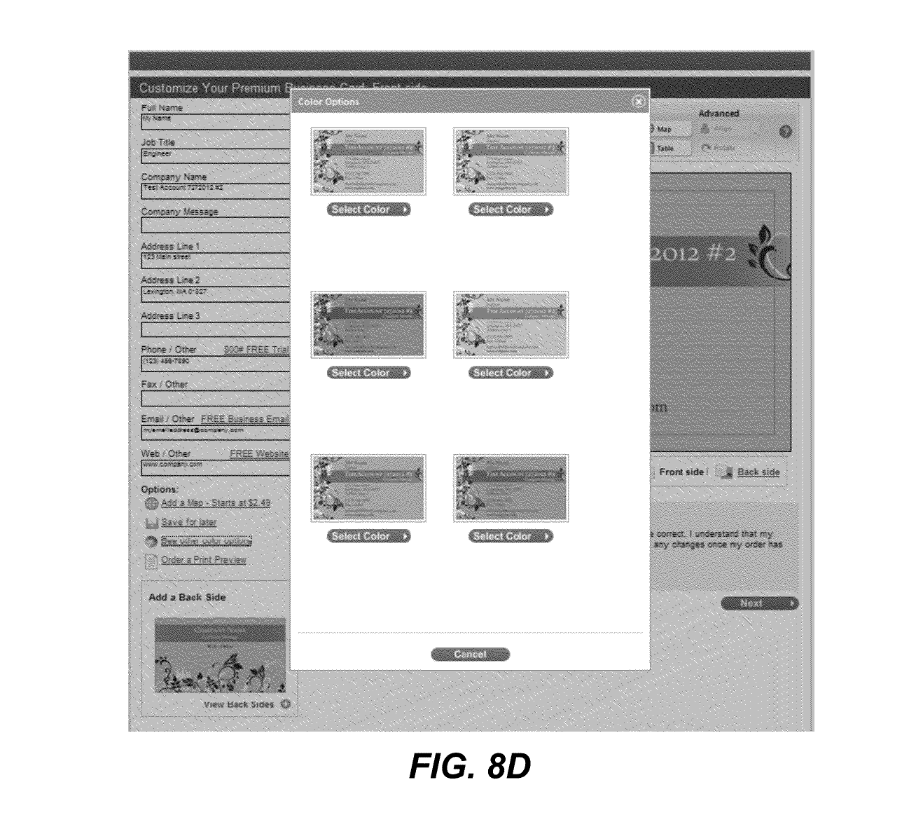

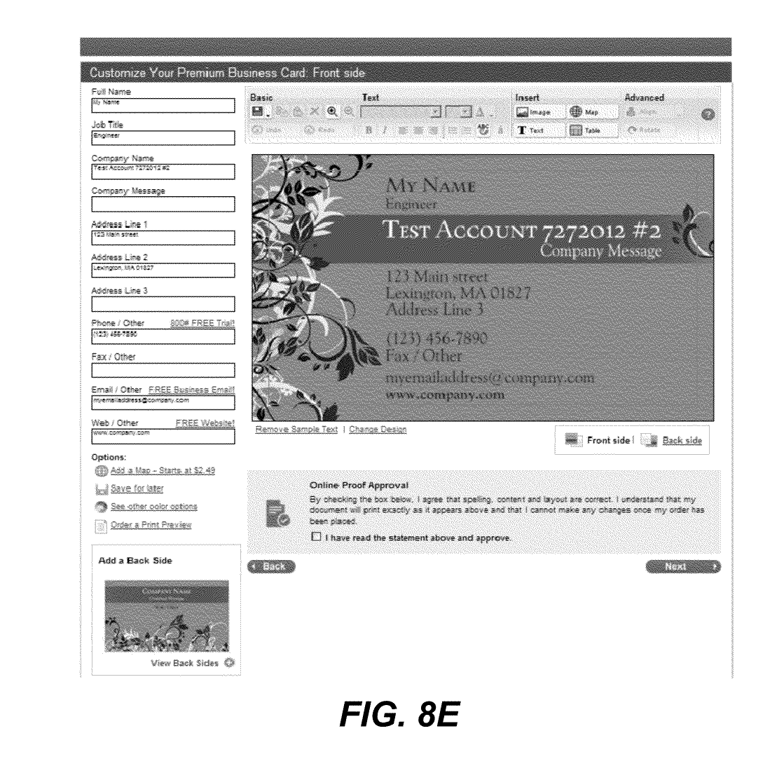

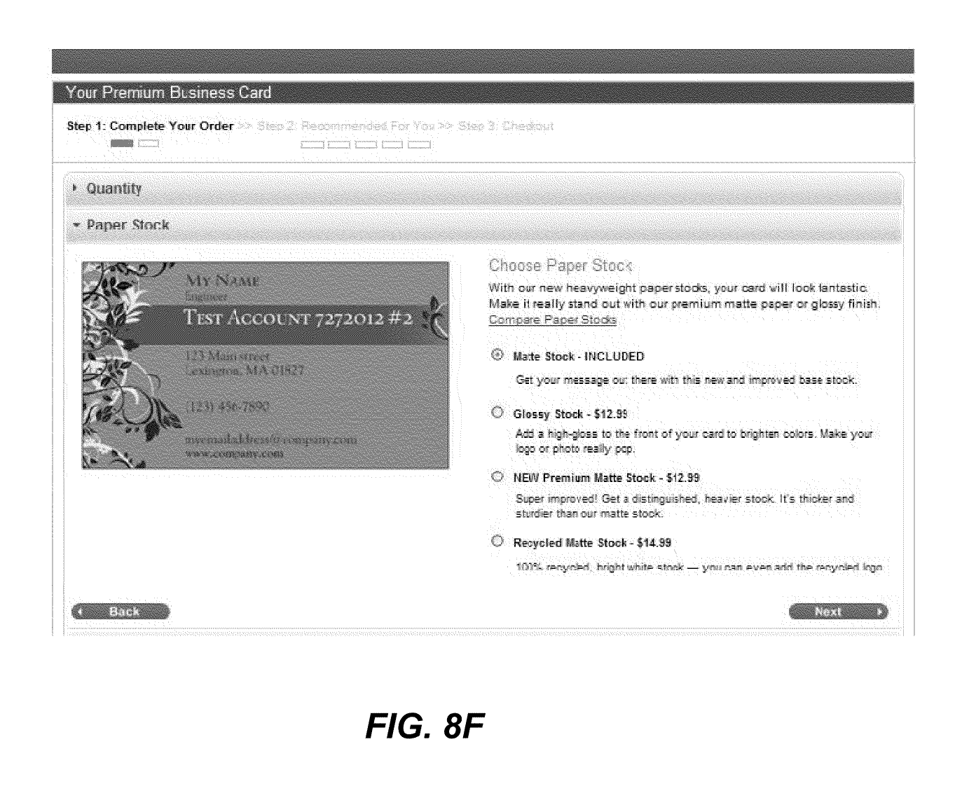

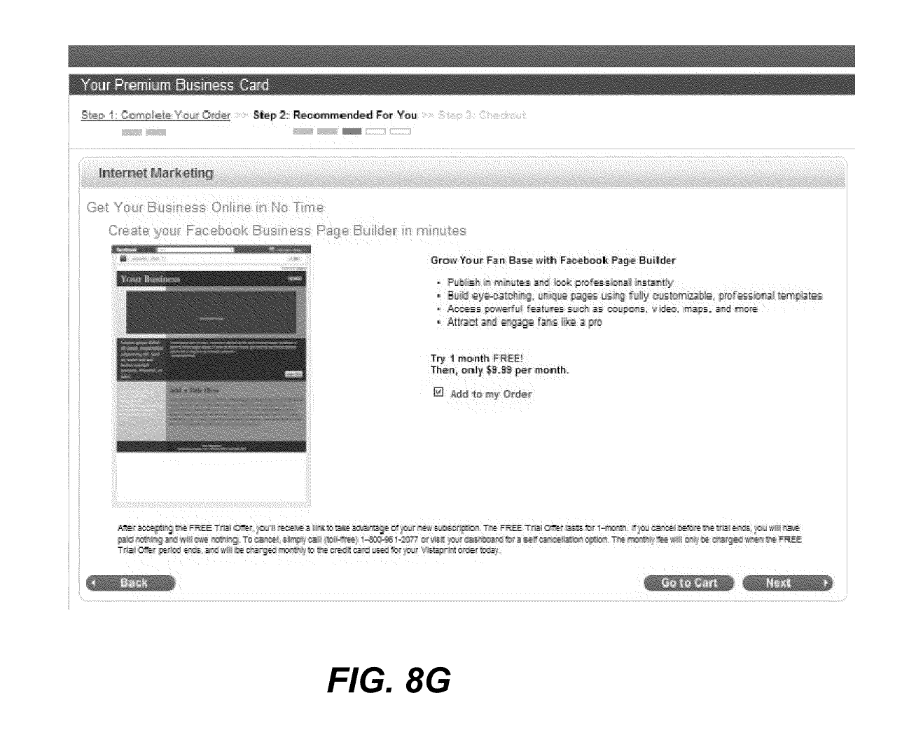

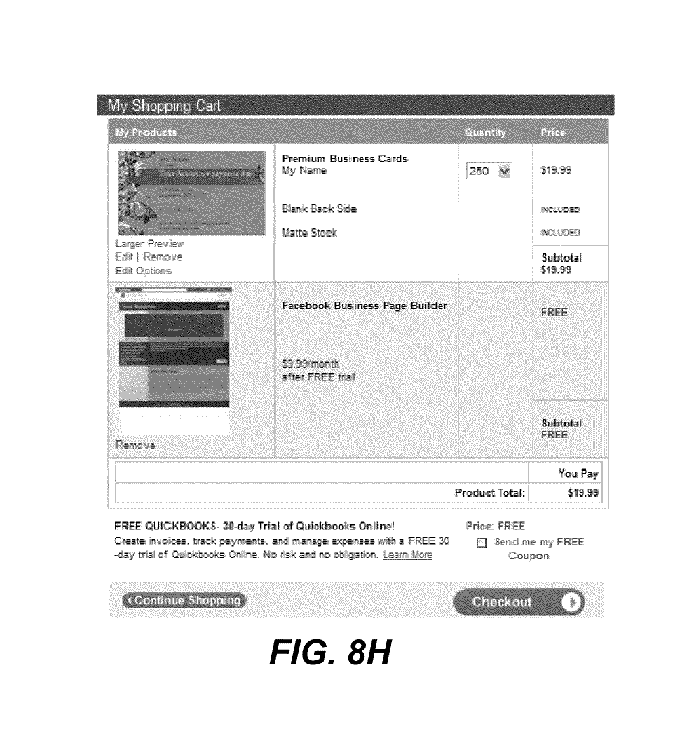

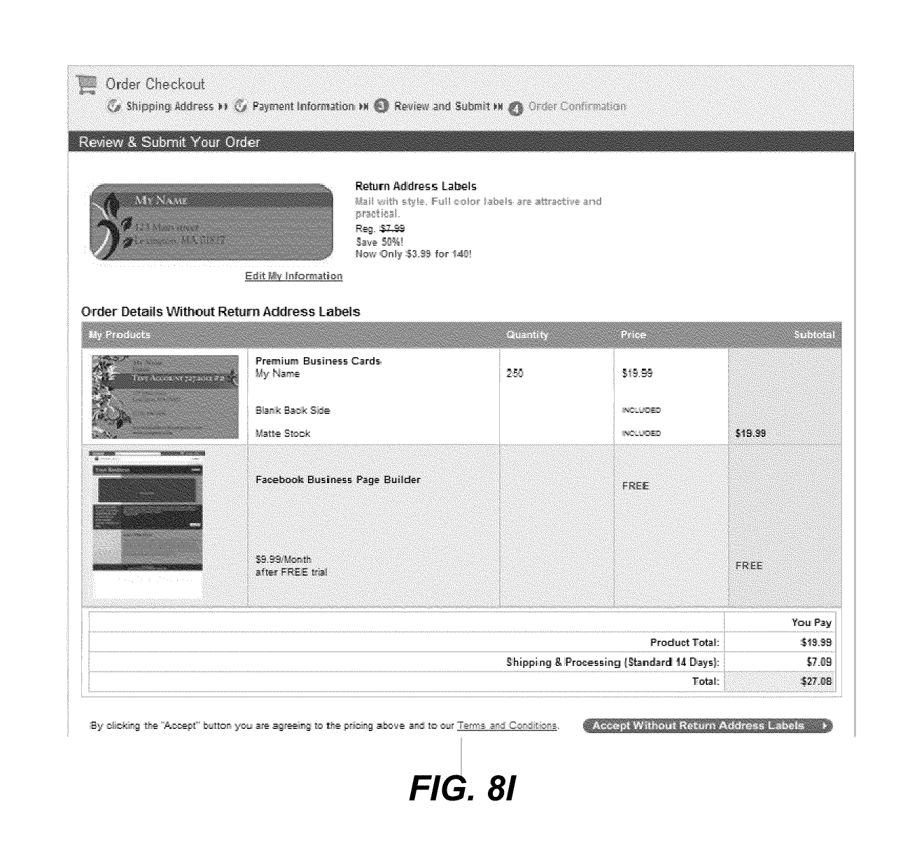

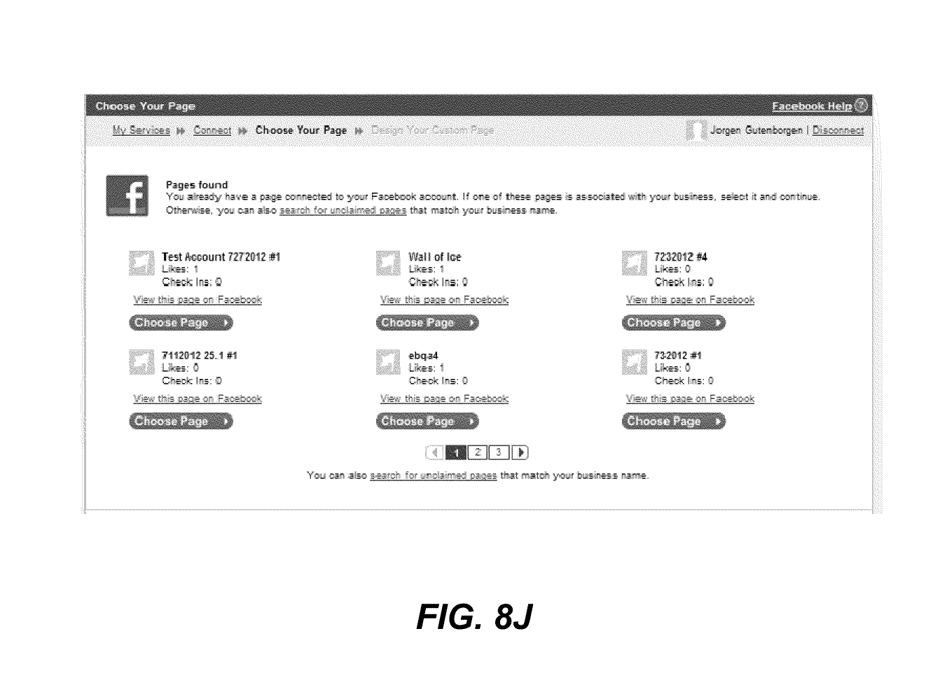

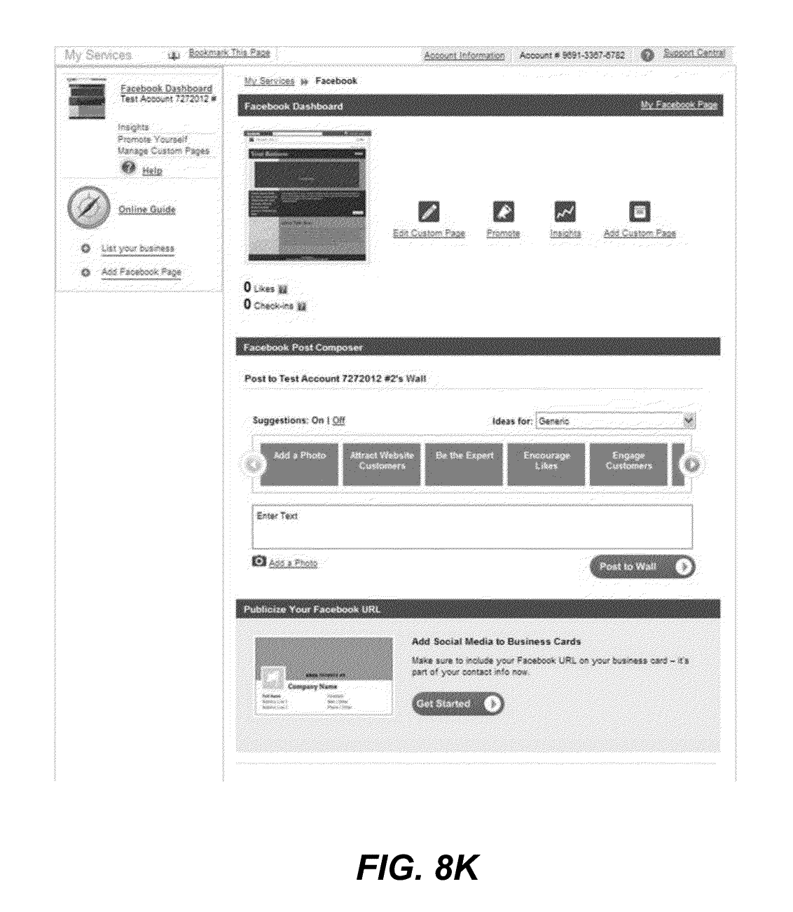

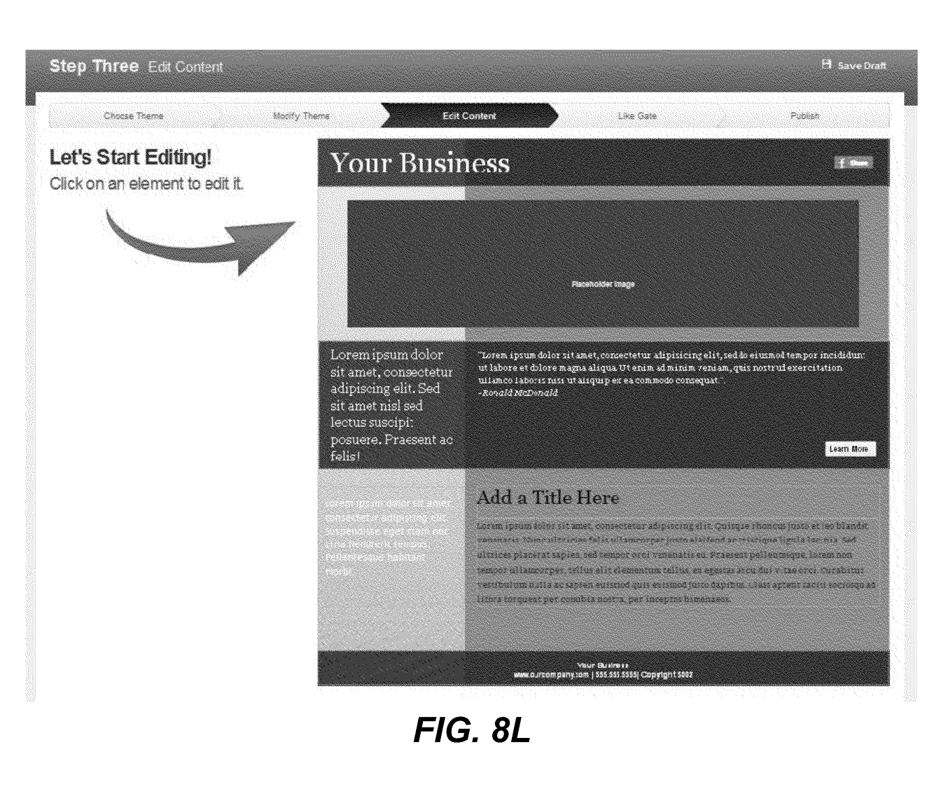

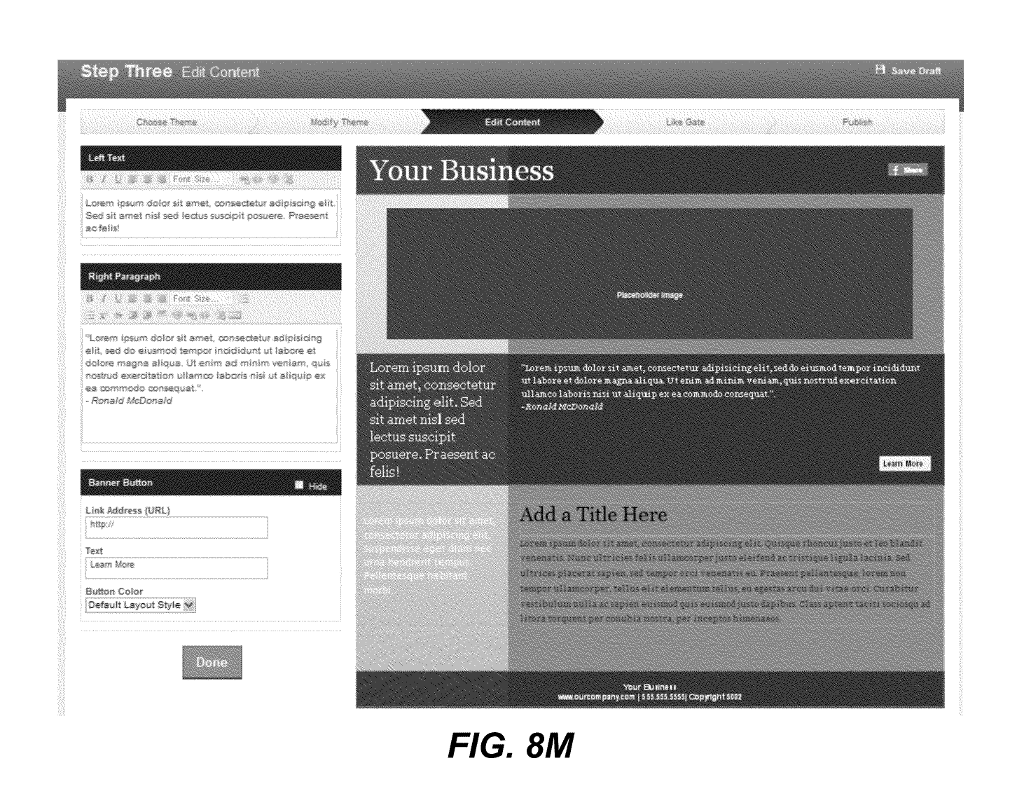

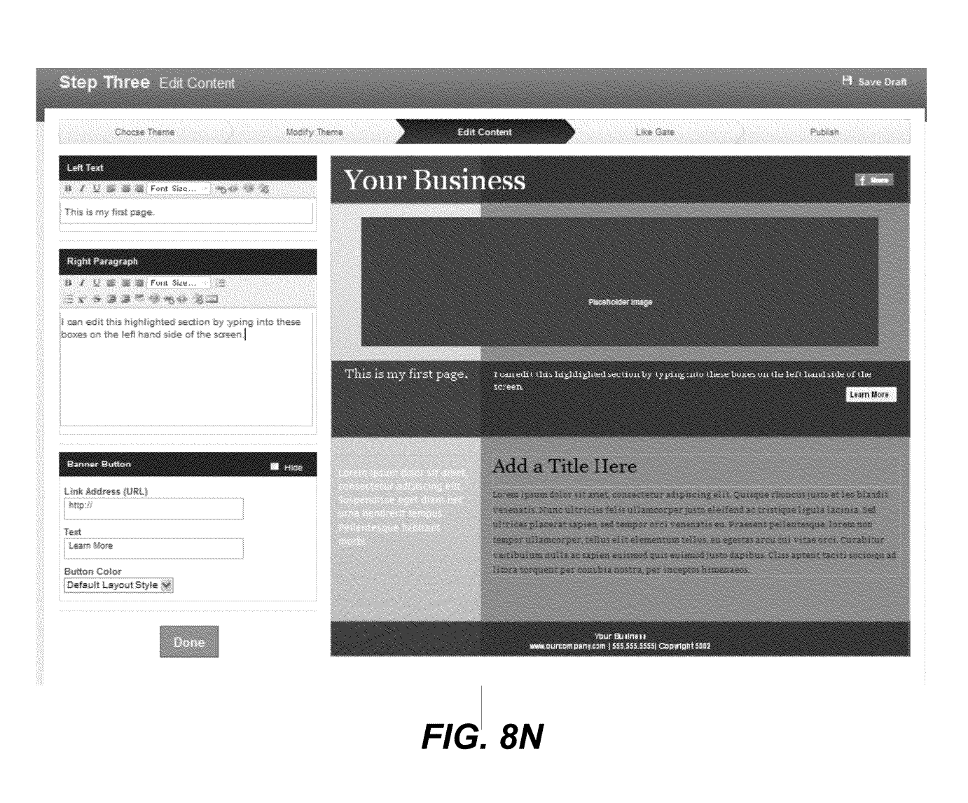

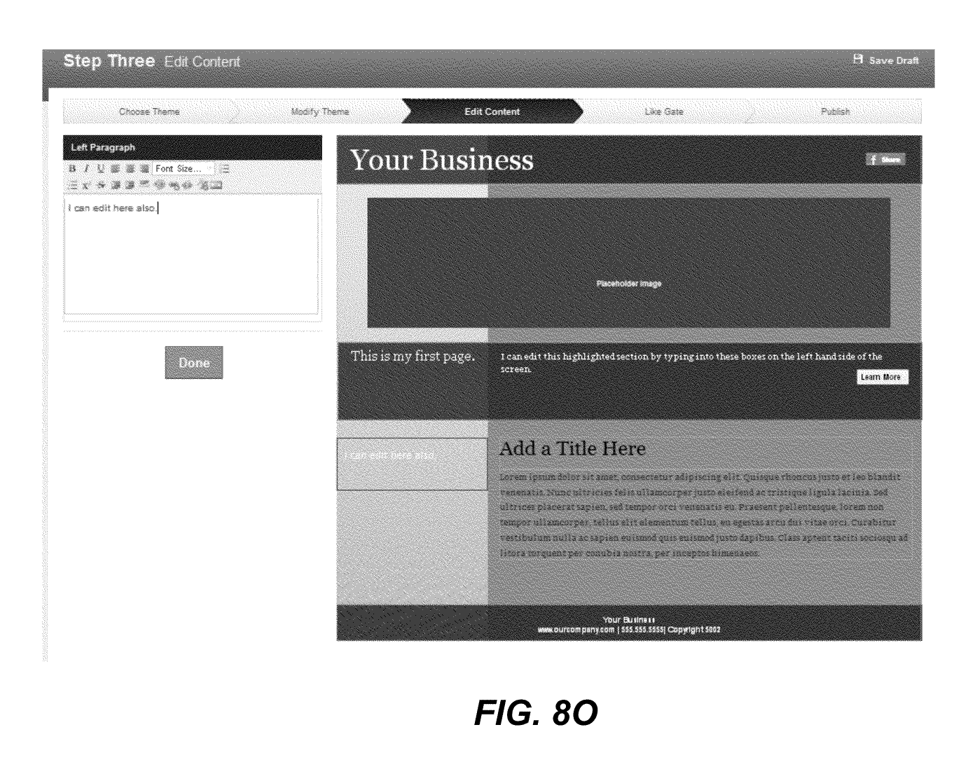

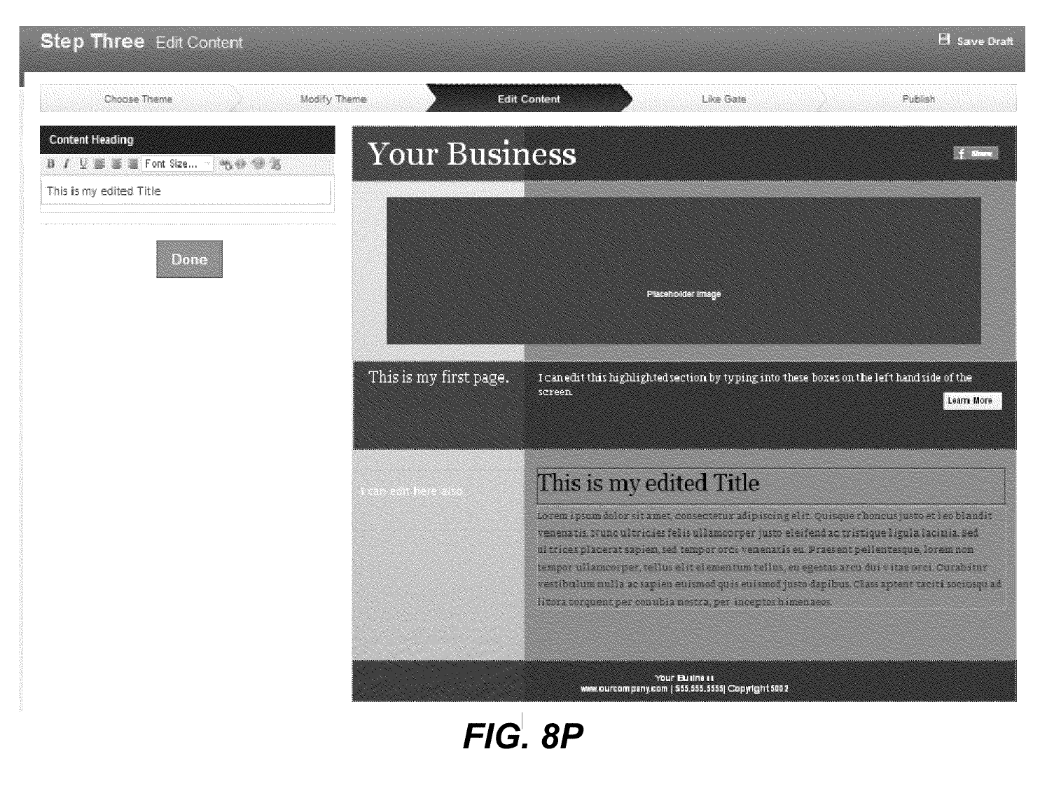

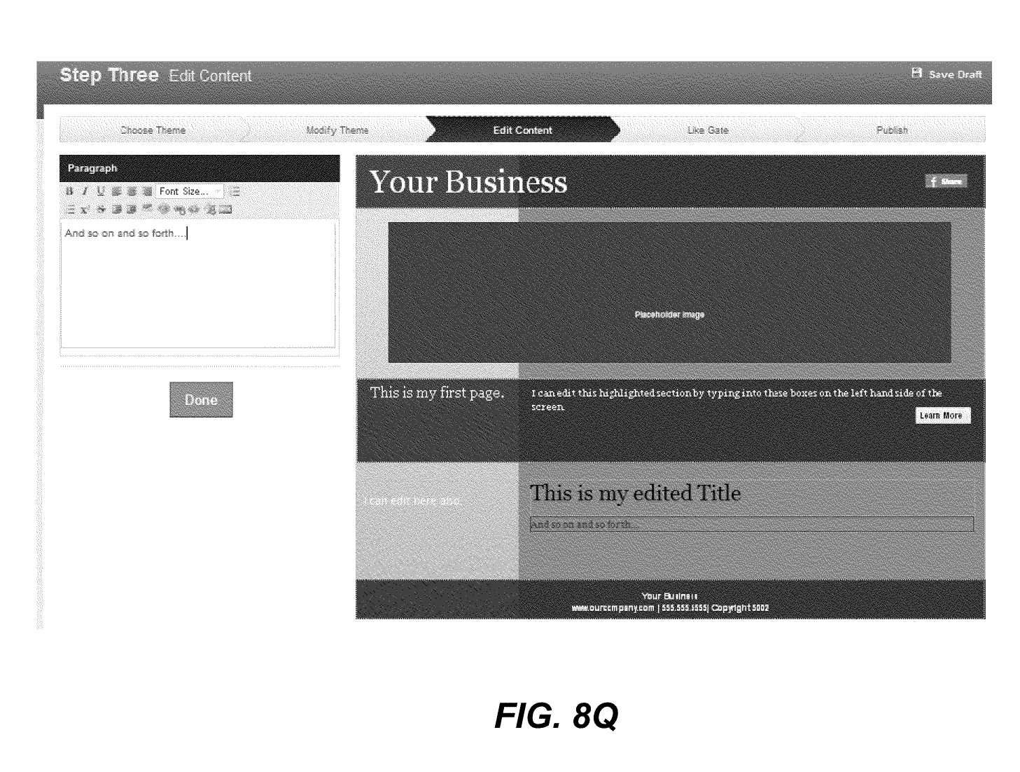

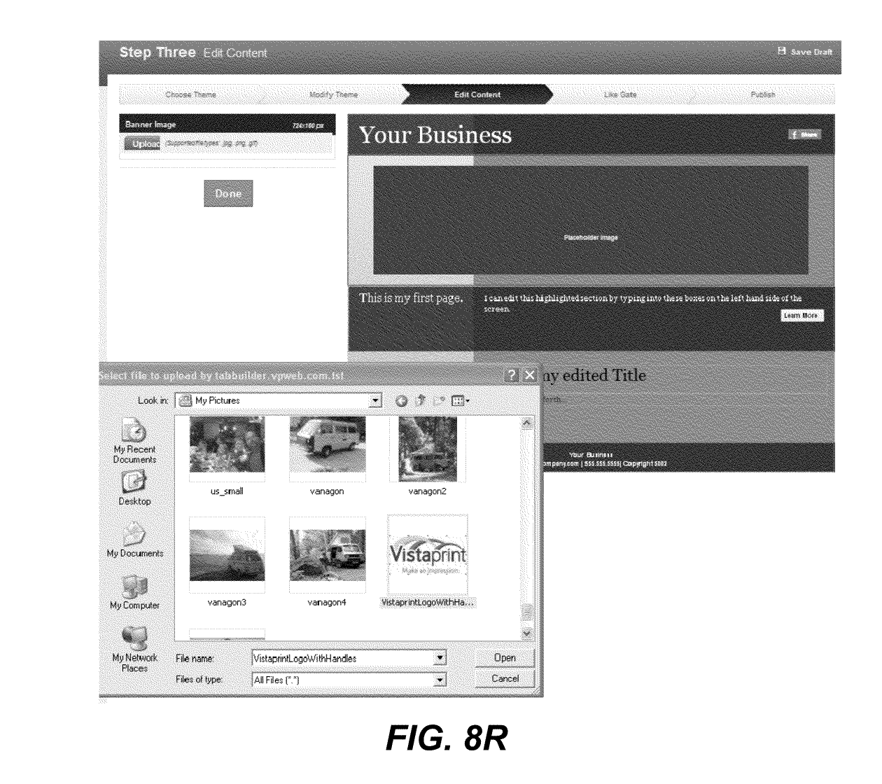

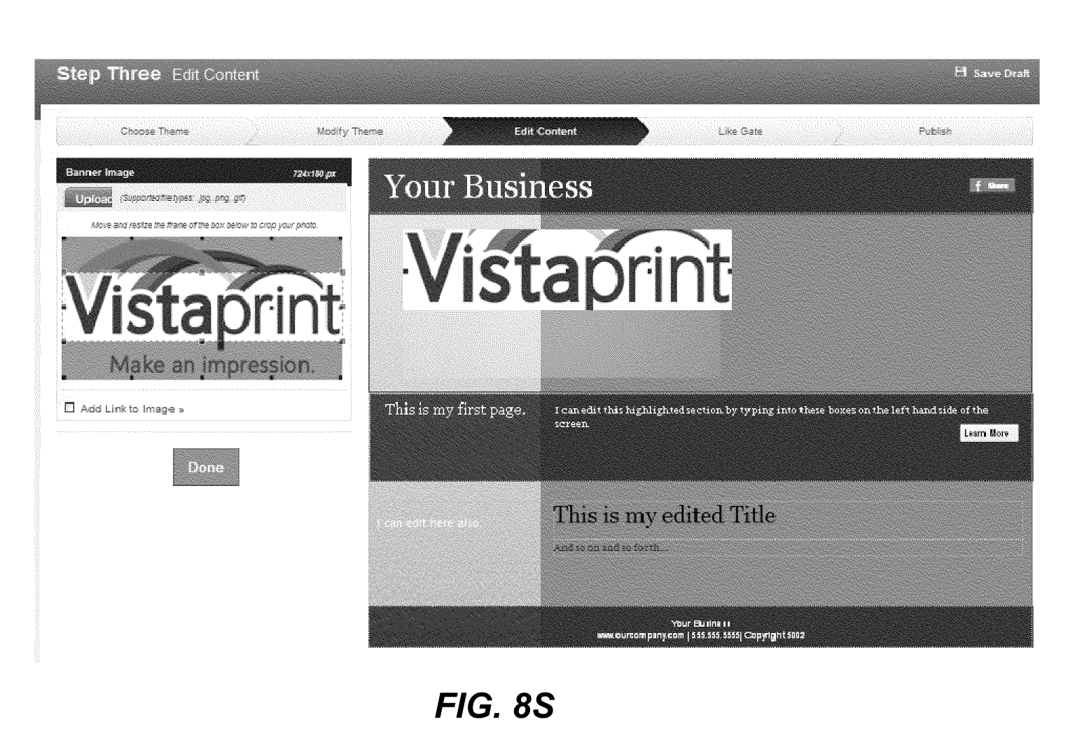

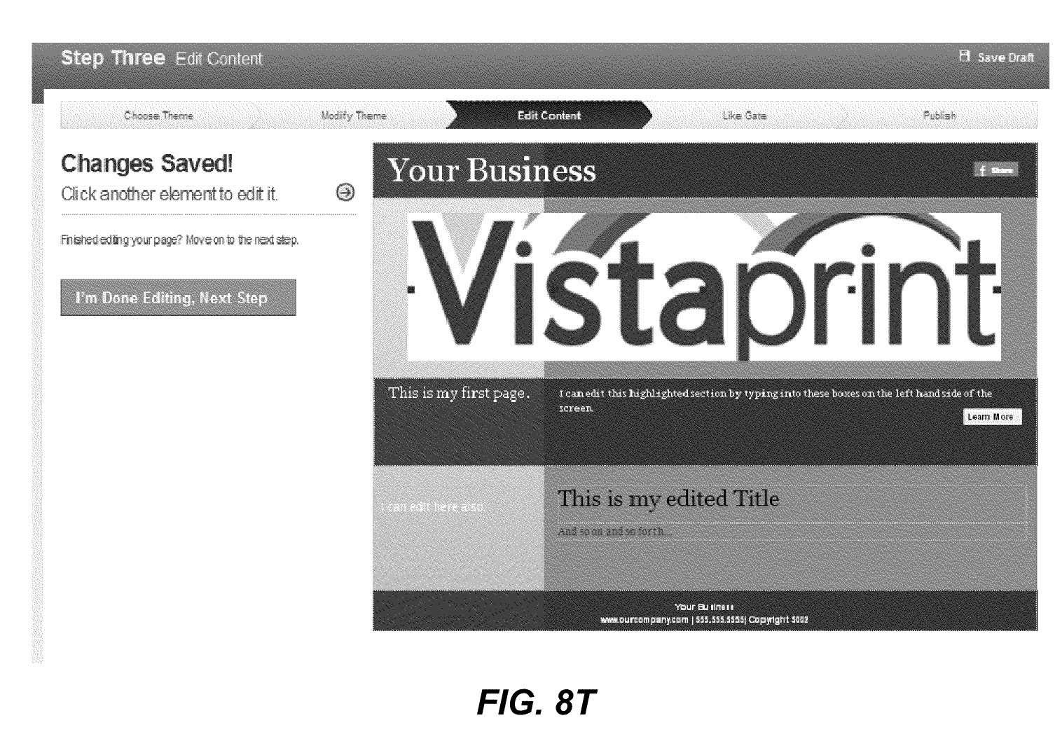

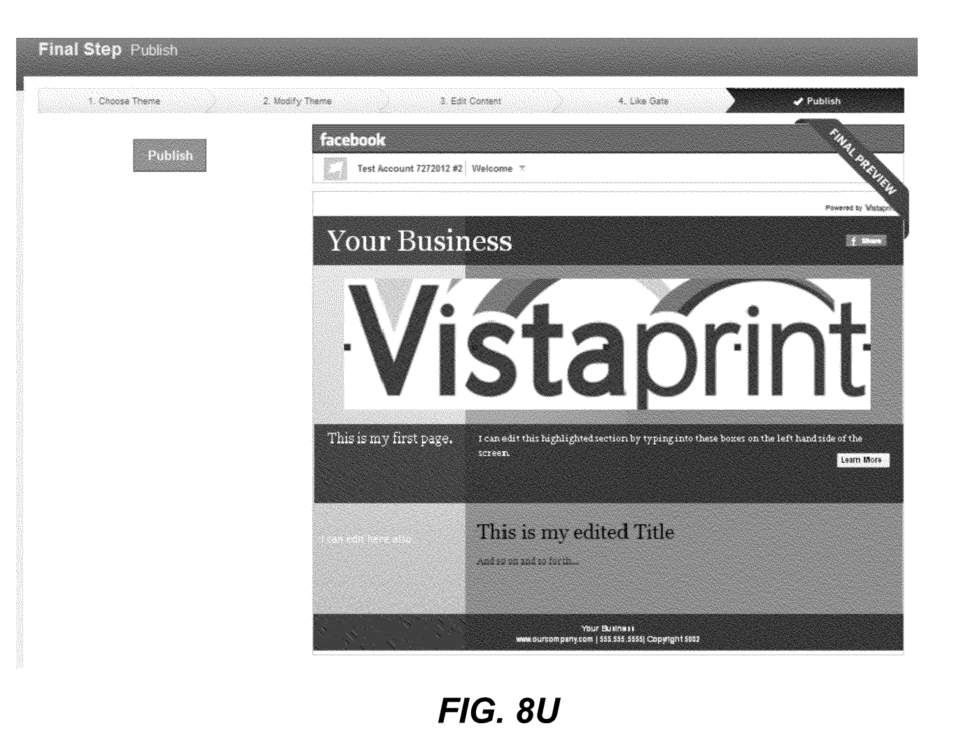

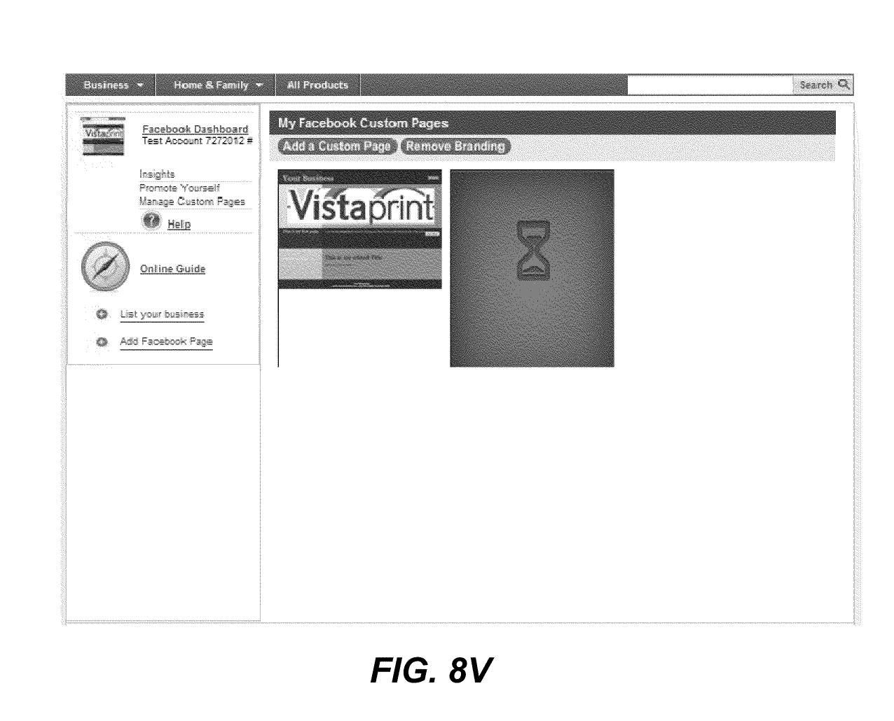

FIGS. 8A-8V together illustrate an example screen flow for the user case of a user design of a business card product and the offering of a matching social media page at a retail promotional products website. It is to be understood that the exemplified flow is illustrative only and not limiting, and that the matching and automated features of the present use case may be applied variously to other use cases.

FIG. 8A shows an example screen shot of a business card gallery with various business card designs from which a user can choose by selecting the corresponding control associated with the selected design. FIG. 8B is an exemplary screen shot of an example business card design studio, whereby the selected design is displayed in a What-You-See-Is-What-You-Get (WYSIWYG) preview area. Various text fields can be filled out and the WYSIWYG preview area is automatically updated, as illustrated in FIGS. 8B and 8C. (Note in FIG. 8B the user has filled out the Company Name, which appears in the preview area, and in FIG. 8C, the user has filled out the remaining fields which correspondingly appear in the preview area.) FIG. 8D shows a popup presented when the user activates a color selection control to view different color options. FIG. 8E shows the state of the customized business card document after the user selects a different color. FIG. 8F shows a step in the checkout process, where the user may select the type of paper on which the business cards are to be printed.

FIG. 8G shows the checkout cart with the preview image of the ordered business card, and an automatically generated preview of a customized social media page presented as an offer to the user. The customized social media page is prepared automatically by the social media configuration server 170 in conjunction with the social media page builder application server 180 using identified assets from the existing business card order. As illustrated, the matching social media page includes content and styling that is identical and/or is coordinated with the content and styling of the business card. FIG. 8I shows one of the final checkout and ordering screen, where the user has selected to order the customized matching social media page.

FIG. 8J shows a screen displayed after the user has been authenticated to the social media service and shows the names of various pages associated with the user's social media service account. FIG. 8K shows a social media page dashboard screen which previews the customized social media page and provides administration controls to allow the user to post to the customized social media page and/or edit the configuration and content of the customized social media page. FIG. 8L shows the social media page editing studio with the matching stylized content in place. The actual user content in areas 34-38 remains editable. FIGS. 8M through 8Q show the user editing the left and right paragraphs and title. FIGS. 8R through 8S show the user inserting an image into the social media page, and FIG. 8T displays the studio when the user saves the page. FIG. 8U shows the preview of the social media page, and FIG. 8V shows the published custom page in the dashboard.

The described implementation may include a particular network configuration but embodiments of the present disclosure may be implemented in a variety of data communication network environments using software, hardware, or a combination of hardware and software to provide the processing functions.

Although this preferred embodiment of the present invention has been disclosed for illustrative purposes, those skilled in the art will appreciate that various modifications, additions and substitutions are possible, without departing from the scope and spirit of the invention as disclosed in the accompanying claims. It is also possible that other benefits or uses of the currently disclosed invention will become apparent over time.

What is claimed is:

1. A system for building social media pages, comprising:
a social media page building engine in first communication with a matching engine which identifies content assets associated with corresponding content assets in a customized electronic document representing a user's customized product, the social media page building engine receiving the identification of the identified content assets and building a social media page for a social media service, the social media page incorporating at least some of the identified content assets.

2. The system of claim 1, further comprising:
a server configured to display on a display screen of a user's computing device the social media page and at least one control which, when activated by the user, triggers an authentication process between the server and the social media service for authenticating the user to a user account at the social media service and loads the social media page into the user's account.

3. The system of claim 1, wherein the matching engine searches the customized electronic document to identify the customized electronic document content assets and to determine the associated content assets and to provide identification of the associated content assets to the social media page building engine for use in building the social media page.

4. The system of claim 3, wherein the associated content assets comprise at least some content which is identical to the corresponding content assets.

5. The system of claim 3, wherein the associated content assets comprise at least one accent image which aesthetically matches at least one image in the customized electronic document.

6. The system of claim 1, wherein the identified content assets comprises at least some styling information.

7. The system of claim 1, wherein the matching engine and the social media page building engine are operated by different parties.

8. The system of claim 7, wherein the social media service is a 3^{rd} party provider different than the parties operating the matching engine and the social media page building engine.

9. The system of claim 1, wherein the social media service is a 3^{rd} party provider different than the one or more parties operating the matching engine and the social media page building engine.

10. A method for generating a social networking site page at a remote social networking site, the method comprising:
receiving, by one or more processors, content from an existing electronic document;
automatically selecting, by one or more processors, at least some of the content from the existing electronic document;
authenticating, by one or more processors, a user to the social networking site;
automatically creating, by one or more processors, a page at the social networking site;
automatically, and without input from the user, provisioning the page with at least some of the selected content from the existing electronic document.

11. The method of claim 10, wherein the provisioned content comprises a header.

12. The method of claim 11, further comprising:
determining a header identifier from the existing electronic document, the header identifier associated with a header in the existing electronic document, the header characterized by a first set of dimensions and containing visual content; and
based on the header identifier, selecting a matching header from a database, the matching header characterized by a second set of dimensions that match dimensions of the header area of the social networking page, the matching header comprising at least some visual content that is identical to the visual content of the header from the existing electronic document; and
instructing the social networking site to insert the matching header into the header area of the social networking page.

13. The method of claim 10, wherein the electronic document is an existing website.

14. The method of claim 10, wherein the electronic document is an electronic document representing a product to be printed.

15. The method of claim 10, wherein the product to be printed comprises one or more of the group comprising a business card, a postcard, a brochure, and a promotional item.

16. The method of claim 10, further comprising:
presenting a graphical user interface to the user, the graphical user interface comprising user-interactive controls which allow the user to edit the created social networking page.
